(19) United States
(12) Patent Application Publication
(10) Pub. No.: US 2025/0283906 A1
(43) Pub. Date: Sep. 11, 2025

(54) SYSTEMS AND METHODS FOR PREPARING AND QUANTIFYING SOLUTIONS

(71) Applicant: Saudi Arabian Oil Company, Dhahran (SA)

(72) Inventors: Refaa E. Bajnaid, Yanbu (SA); Raad Mulla, Yanbu (SA)

(21) Appl. No.: 18/597,327

(22) Filed: Mar. 6, 2024

(51) Int. Cl. G01N 35/10; G01N 31/16

(52) U.S. Cl. CPC G01N 35/10; G01N 31/16; G01N 2035/1058

(57) ABSTRACT

Systems and methods for the preparation and quantification of chemical solutions. The system includes a working solution preparation section, a standard solution preparation section, and a titration section.

### TECHNICAL FIELD

This document relates to systems, apparatuses, and methods for preparing and quantifying chemical solutions.

### BACKGROUND

Errors and inconsistencies in the preparation of chemical solutions negatively influence the quality of subsequent research and analyses conducted with these solutions. Reducing error in solution preparation remains an important endeavor in many areas of scientific research.

### SUMMARY

This disclosure describes a system for preparing and quantifying a chemical solution. In some implementations, a system for preparing and quantifying a chemical solution includes a control panel configured to control a process for preparing and quantifying a solution, a plurality of storage tanks configured to store solvents, solutions, and/or solutes, a working solution section, a standard solution section, a titration section and a controller including a processor and a data store. The data store includes a working solution module, wherein the working solution module includes instructions to direct the processor to prepare a working solution from solvents, solutions and/or solutes stored in the storage tanks, wherein the working solution is prepared in the working solution section. The data store includes a standard solution module, wherein the standard solution module includes instructions to direct the processor to prepare a standard solution from solvents, solutions and/or solutes, wherein the standard solution is prepared in the standard solution section. The data store includes a titration module, wherein the titration module includes instructions to direct the processor to titrate a portion of the working solution using a portion of the standard solution.

In some implementations, a method for preparing and quantifying a chemical solution using an automated solution preparation instrument includes accepting target values for a working solution, and in response to the target values, weighing an amount of solid chemical or partitioning an amount of liquid, dispensing the amount of solid chemical or the amount of liquid into a working solution vessel, dispensing an amount of solvent into the working solution vessel to yield a working solution, dispensing an amount of standard solution to a standard solution vessel, transferring a portion of the working solution to a titration section, and titrating the portion of the working solution using a portion of the standard solution.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1A is a front perspective view of a solution preparation instrument that can be used to prepare and quantify a working solution.

FIG. 1B is a back perspective view of a solution preparation instrument.

FIG. 2 is a flow chart of an example method of preparing and quantifying a working solution using a solution preparation instrument.

FIG. 3 is a block diagram of a system that may be used for controlling a solution preparation instrument.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure, in part, are systems, apparatuses, and methods to reduce errors in the preparation of chemical solutions. Provided herein is a fully automated instrument that can prepare and quantify chemical solutions, eliminating several sources of user error. The device includes a fully automated transfer features that do not require user intervention and therefore reduce error, contamination, and costs. Further, the instrument can reduce waste, since erroneously prepared solutions are sometimes discarded, wasting reagents and the time spent preparing the solution. The instrument's ability to provide high-purity chemical solutions for use in various analyses improves laboratory efficiency, precision, and accuracy. Further, it reduces costs, time, and chemical waste by minimizing the potential for user error. By automating the preparation process, potential sources of error and contamination are avoided. This has a significant impact on the quality of subsequent analyses and improves overall laboratory performance. For example, testing for the presence of chloride, which is highly corrosive and used to monitor the performance of corrosive inhibitors, requires the precise preparation of silver nitrate (AgNO₃) solutions. By eliminating human errors during the preparation process, the accuracy of the chloride corrosion analyses is improved, enhancing corrosion monitoring and maintaining plant integrity. In another example, testing for the alkalinity as calcium carbonate, which is used to monitor scaling inside piping, requires the precise preparation of hydrochloric acid (HCl) solutions. By eliminating human errors during the preparation process, the accuracy of the alkalinity as calcium carbonate analysis is improved, enhancing scaling monitoring and sustaining piping integrity.

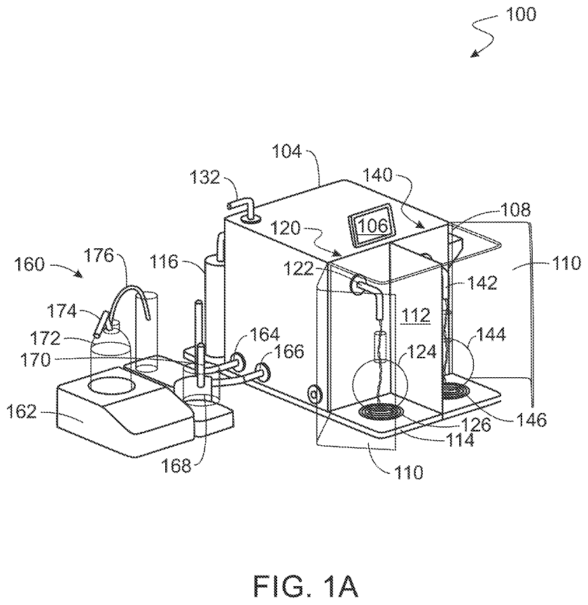

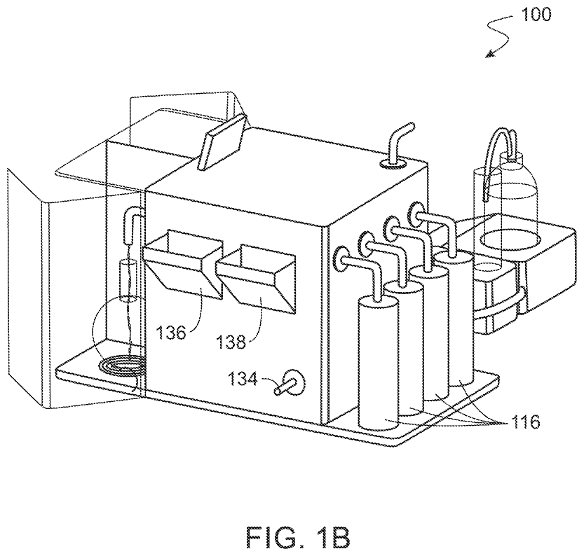

FIG. 1A is a front perspective view of a solution preparation instrument 100 that can be used to prepare and quantify a working solution. FIG. 1B is a back perspective view of a solution preparation instrument 100. The solution preparation instrument 100 includes three sections. In a working solution section 120, a working solution is prepared. The working solution is prepared by transferring an amount of chemical, solution, solvent, or combination thereof to a working solution vessel.

In a standard solution section 140, a standardization solution is prepared. The standard solution is a chemical solution of a known concentration. In some implementations, the standard solution is preprepared or purchased from a manufacturer.

In a titration section 160, the standard solution is used to titrate the working solution, to provide a precise quantification of the working solution. The sections 120, 140, and 160 are directly connected. For example, the sections 120 and 140 are fluidly connected to the titration section 160. Accordingly, the instrument includes all three sections.

FIG. 1A is a front perspective view of a solution preparation instrument 100. The instrument 100 includes an outer casing 104 and a control panel 106. A user can use the control panel 106 to enter information such as the desired final solution concentration, size of the solution flask, stock solution concentration, and final solution concentration. A user can also monitor the solution preparation and quantification processes on the control panel 106. The instrument 100 includes a support base 114. The support base includes a space for at least two receptacles or vessels, for example two volumetric flasks. A first vessel is the working solution vessel 124. The working solution will be mixed and formed in the working solution vessel 124. The support base also includes a space for a second vessel, the standard solution vessel 144. The preprepared standard solution can be mixed, formed, or diluted in the standard solution vessel 144, or transferred without alteration to the standard solution vessel 144.

The support base 114 includes a first docking region 126. The first docking region 126 is positioned underneath a working chemical and solvent dispenser 122. The working solution vessel 124 is placed on the first docking region 126. Accordingly, the working solution vessel 124 is directly underneath or positioned around the working chemical and solvent dispenser 122. In some implementations, the first docking region 126 is recessed relative to the surface of the support base 114, and the working solution vessel can rest within the recessed docking region. The recessed region can prevent the vessel from tipping or falling during the solution preparation process. In some implementations, the first docking region is surrounded by a raised curb. The raised curb can encircle or partially encircle the working solution vessel to prevent the vessel from tipping or falling during the solution preparation process.

The docking region 126 can include a heating element, a cooling element, a mixing element, or any combination thereof. The heating and/or cooling system will be activated at the beginning of the solution preparation process. In some implementations, the heating and/or cooling system will be activated in response to instructions from a processor. The heating element can be used to heat the working solution vessel 124 and any solution within the working solution vessel. Heating the solution can remove any dissolved gases in the solution, for example, water vapor or volatile organic compounds.

The cooling element can be used to cool the working solution vessel 124 and any solution within the working solution vessel. The cooling element can help maintain a consistent temperature for chemical solutions, which is important for many chemical reactions and processes. Controlling the temperature of a solution can help to ensure that it reacts or behaves as expected, and can improve the accuracy and reliability of experimental results. The cooling element can also be used to slow down or control the rate of chemical reactions. For example, some reactions may be exothermic (release heat) and require cooling to prevent them from becoming uncontrollable or damaging equipment. Further, the cooling element can be used to preserve the stability and shelf-life of chemical solutions. Many chemical compounds are sensitive to heat and can deteriorate over time if not stored at the appropriate temperature. The cooling system can also be used to ensure safe handling of chemical solutions. Some chemicals can become volatile or hazardous if heated, and cooling can help prevent accidents or exposure to harmful substances.

The mixing element can be used to mix the working solution, for example, by inducing a magnetic stir bar placed inside the working solution vessel to spin.

The support base 114 includes a second docking region 146. The second docking region 146 is positioned underneath a standard chemical and solvent dispenser 142. The standard solution vessel 144 is placed on the second docking region 146. Accordingly, the standard solution vessel 144 is directly underneath or positioned around the standard chemical and solvent dispenser 142. In some implementations, the second docking region is recessed relative to the surface of the support base 114, and the standard solution vessel can rest within the recessed docking region. The recessed region can prevent the vessel from tipping or falling during the solution preparation process. In some implementations, the second docking region is surrounded by a raised curb. The raised curb can encircle or partially encircle the standard solution vessel to prevent the vessel from tipping or falling during the solution preparation process.

The docking region 146 can include a heating element, a cooling element, a mixing element, or any combination thereof, as described with respect to docking region 126. The heating element can be used to heat the standard solution vessel 144 and any solution within the standard solution vessel. Heating the solution can remove any dissolved gases in the solution, for example, water vapor or volatile organic compounds. The cooling element can be used to cool the standard solution vessel and any solution within the standard solution vessel. The mixing element can be used to mix the standard solution, for example, by inducing a magnetic stir bar placed inside the standard solution vessel to spin.

The support base 114 can move up and down in the vertical direction, which will raise and lower the working solution vessel and the standard solution vessel relative to the chemical and solvent dispensers 122 and 142. The moveable support base can ensure that the dispensers are disposed within the solution vessel during operation of the instrument. The based can move automatically, for example, in response to instructions from a processor.

As discussed herein, the instrument includes a working chemical and solvent dispenser 122 and a standard chemical and solvent dispenser 142. The working solution vessel 124 and the standard solution vessel 144 are configured so that the dispensers extend into the vessels. For example, the vessels can be volumetric flasks placed in the instrument such that the dispensers are inserted into the neck of the volumetric flasks. This configuration can prevent the loss of solvent or chemicals to splashing or spilling.

The dispensers 122 and 142 provide solid chemicals, solvents, solutions, or any combination thereof to the working and standard solution vessels 124 and 144. The instrument includes storage containers and/or tanks that can be filled with the desired chemicals and/or solvents.

The instrument 100 includes a scale. In some implementations the scale is located inside the casing. The scale can be used to measure a solid chemical substance present in a first drawer 136 and/or a second drawer 138 of the device. The weighing method can be automatic. A small amount of solid material is dropped automatically on the scale by an internal dispenser until the required weight is obtained. The solid material can be drawn from a first storage drawer 136 and/or a second storage drawer 138. When the required weight is obtained, the outlet of the internal dispenser will be closed automatically. The solid chemicals are transferred to the working vessel 124 or the standard vessel 144. The solid chemicals are transferred via tubing and via the dispensers 122 or 142.

In some implementations, the dispensers are in fluid connection with at least one storage tank 116. Solvent or solutions from the storage tank are transferred from the storage tank to the working solution vessel or the standard solution vessel via the working chemical and solvent dispenser 122 or the standard chemical and solvent dispenser 142.

The instrument 100 can include dedicated gas purge lines and connections to facilitate the flow of a purging gas. The purge lines are separate from the main chemical lines and are coupled and configured for purging purposes. Purge valves and regulators are installed at strategic points along the chemical lines and components. These valves control the flow of the purging gas during the purging process. The system can include a gas regulator to maintain a consistent pressure of the purging gas.

The purging process is typically automated and controlled by a central control unit, and can be programmed using the control panel 106. The instrument 100 can be programmed with a specific purge sequence, which determines the order in which the purge valves open and close. The timing of the purging process is also defined to ensure purging of the system.

The flow rate of the purging gas during the purging process is controlled based on the system requirements and to ensure an adequate flow rate to effectively flush out gases other than the purging gas. The instrument can include safety measures for the use of a purging gas. The safety measures can include pressure relief valves, pressure sensors, and alarms to monitor and maintain safe operating conditions.

The instrument 100 includes a gas inlet 132 (shown in FIG. 1A). The gas inlet 132 can be attached to an air source and/or the purging gas source. The air source can be atmospheric air. In some implementations, the purging gas is nitrogen gas (N₂) and the gas inlet 132 is attached to a nitrogen gas source. Example nitrogen gas sources include a dedicated nitrogen generator or a pressurized nitrogen cylinder. The gas inlet 132 is in fluid communication with the working chemical and solvent dispenser and the standard chemical and solvent dispenser. Accordingly, the instrument can be used to purge the working solution and the standard solution of any dissolved gasses by bubbling air or an inert gas through the working solution and/or the standard solution. For example, the instrument can bubble N₂ gas through the working and/or standard solutions. The specific method used for purging a chemical solution will depend on the type of solution being used and the specific impurities or gases that need to be removed.

In some implementations, the instrument 100 can include a solvent purging system. The solvent purging system includes dedicated purge lines or circuits to facilitate the purging process. A suitable purging solvent, such as water or a cleaning solution, can be used to flush the system and remove any residual chemicals or contaminants. The choice of purging solvent depends on the specific application and the chemicals being used in the system. The purging system includes purge valves placed along the chemical lines and components. The valves are opened during a purging process to allow the purging solvent to flow through the system and flush out any residue. The instrument 100 can be programmed with a specific purge sequence to ensure effective cleaning. This sequence determines the order in which the purge valves are opened and closed, as well as the duration and flow rate of the purging solvent. The purging process is typically automated and controlled by a central control unit. This allows for precise control over the purging sequence and parameters, ensuring consistent and reliable cleaning. In some implementations, a user can program the purging process using the control panel 106. In some implementations, the purging process occurs automatically, for example, after each use of the machine or at pre-determined intervals. Accordingly, the instrument can prevent errors due to a clack of clean chemical tools and/or equipment.

The instrument 100 can include sensors or monitoring devices to verify the effectiveness of a solvent purging process. This can include measuring the concentration of residual chemicals or conducting visual inspections to ensure the system is properly cleaned.

The instrument 100 includes shields to prevent dust, debris, and other contaminants from entering the working and standard solution vessels during solution preparation. The instrument includes a top shield 108, and left and right doors 110. The doors 110 can be hinged to the instrument and can open and close manually. In some implementations, the doors can be held closed by a magnet or latch. In some implementations, the top shield 108 and the doors 110 can be transparent. For example, the top shield 108 and the doors 110 can be formed from plexiglass or glass. The transparent shields allow the reaction to be monitored visually by a user.

In some implementations, the instrument can include a center partition 112. The center partition is located between the first docking region and the second docking region and is configured to separate the working solution vessel and standard solution vessel during solution preparation. The center partition is affixed to or passes through the support base 114 and the top shield 108. The center partition can add stability to the instrument and prevent cross-contamination between the working solution vessel and the standard solution vessel.

The instrument also includes a deionized water inlet 134. The deionized water inlet can be in fluid communication with the tubing inside the system, as well as with the working chemical and solvent dispenser 122 and the standard chemical and solvent dispenser 142.

The instrument includes a titration section 160. After the working solution and the standard solutions are prepared, the working solution and the standard solution are transferred to the titration section 160. The titration section 160 is used to accurately quantify the concentration of the working solution using a titration process.

The titration section 160 includes a titration support base 162. The instrument includes working solution transfer tubing 164. The working solution transfer tubing 164 is in fluid communication with the working solution vessel 124 and a titration reaction vessel 168. The instrument can transfer a portion of the working solution from the working solution vessel 124 to the titration reaction vessel 168 via the working solution transfer tubing 164.

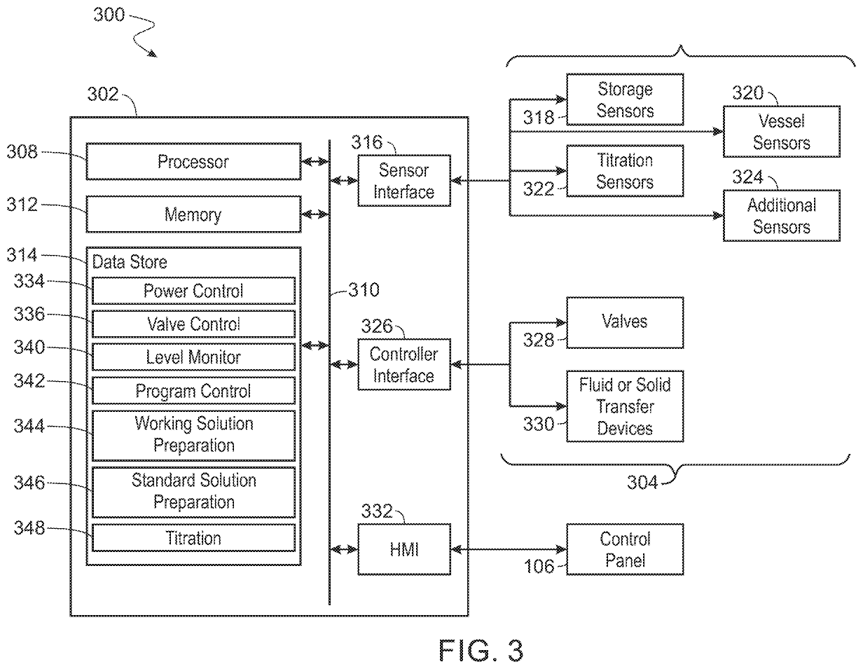

The instrument includes standard solution transfer tubing 166. The standard solution transfer tubing 166 is in fluid communication with the standard solution vessel 144 and the titration reaction vessel 168. The instrument can transfer a portion of the standard solution from the standard solution vessel 144 to the titration reaction vessel 168 via the standard solution transfer tubing 166. The standard solution can be added incrementally to the titration reaction vessel 168 as the titration reaction proceeds. It is possible to control by setting the amount of solution that will be transferred through the tubes to the titration reaction vessel. In other words, after completing the preparation, the value of the solution to be transferred can be entered via the control panel, as described with respect 106 of FIG. 3. Accordingly, the standard solution can be used to quantify the working solution using a titration reaction.

The titration section 160 includes a reaction probe 170 that is inserted into the titration reaction vessel 168. The reaction probe 170 can monitor the titration reaction an indicate when a titration endpoint has been reached. The titration section 160 includes a source of a titration indicator, for example a color changing indicator. In some implementations, the titration indicator can be methyl orange, methyl red, phenolphthalein, fericamino, or methyl purple, among others. The titration indicator is added to the titration reaction vessel before the titration reaction begin.

The titration section 160 also includes a container 172 configured to store chemicals needed for the titration reaction. The titration section 160 includes a piston 174. The piston can be used to ensure that the titration line is clean. The piston 174 is installed on the top of the container 172. The piston 174 is connect to a transfer line 176. The transfer line can be used to transfer a chemical solution to the titration reaction vessel 168.

The instrument can include one or more storage tanks. In some implementations, the instrument includes storage tanks 116. These storage tanks are in fluid communication with the working chemical and solvent dispenser 122 and/or the standard chemical and solvent dispenser 142. The storage tanks can be configured to hold liquids, chemicals, and/or solvents. In some implementations, one or more of the storage tanks can hold liquid chemicals. In some implementations, one or more of the storage tanks can hold deionized water.

The instrument is programmed with basic chemical equations that can be used to prepare different kinds of chemical solutions, as described in the examples. In addition, the instrument can be programmed to prevent incompatible substances from being prepared in the same vessel, for example by displaying a warning that the requested combination of chemicals or solutions is unsafe.

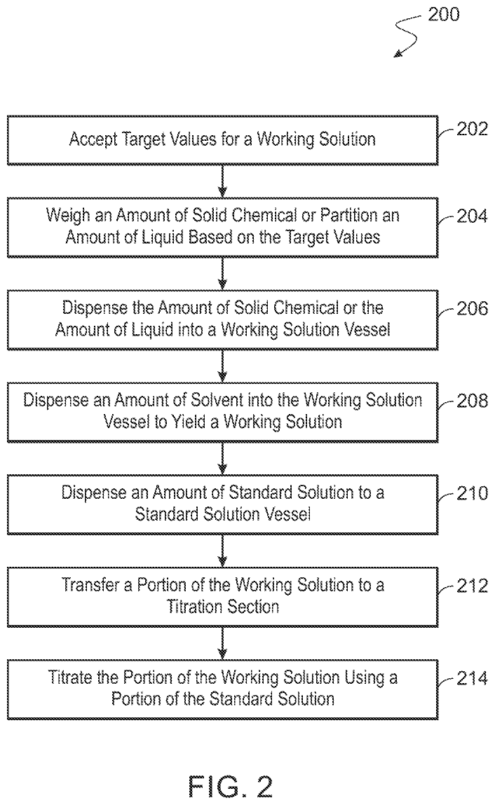

FIG. 2 is a flow chart of an example method 200 of preparing and quantifying a working solution using the instrument 100. At 202, the instrument accepts target values for a working solution. For example, the target values can include solutes, solvent, the desired concentration of the solution, the desired pH of the solution, and the final volume of solution.

At 204, the instrument automatically weighs an amount of solid chemical or partitions an amount of liquid based on the target values.

At 206, the instrument dispenses the amount of solid chemical or the amount of liquid into a working solution vessel.

At 208, the instrument dispenses an amount of solvent into the working solution vessel to yield a working solution. In some implementations, the working solution is stirred. In some implementations, the working solution is heated. In some implementations, the working solution is cooled. In some implementations, the working solution is purged with an inert gas.

At 210, the instrument dispenses an amount of standard solution to the standard solution vessel. In some implementations, the instrument dispenses an amount of solvent to the standard solution vessel to dilute the standard solution.

At 212, the instrument transfers a portion of the working solution to a titration section.

At 214, the instrument titrates the portion of the working solution with a portion of the standard solution from the standard solution vessel to quantify the working solution. In some implementations, the instrument alters the working solution in the working solution vessel based on the results of the titration. For example, the working solution can be diluted by dispensing additional solvent into the working solution vessel. In another example, the concentration of the working solution can be increased by dispensing an additional amount of solid solute into the working solution vessel. In another example, an acid or a base can be dispensed into the working solution vessel to lower or raise the pH of the working solution.

FIG. 3 is a block diagram of a system 300 that may be used for controlling a solution preparation instrument 100. Like numbered items are as described with respect to FIGS. 1A and 1B. The system 300 includes a controller 302, sensors/actuators 304, and a control panel 106. In some embodiments, controller 302 is a microcontroller, for example, mounted in the enclosure with the control panel 106. In other embodiments, the controller 302 is a virtual controller running on a processor in a DCS, on a virtual processor in a cloud server, or using other real or virtual processors.

The controller 302 includes a power control 334. The controller 302 includes a processor 308. The processor 308 may be a microprocessor, a multi-core processor, a multithreaded processor, an ultra-low-voltage processor, an embedded processor, or a virtual processor. In some embodiments, the processor 308 may be part of a system-on-a-chip (SoC) in which the processor 308 and the other components of the controller 302 are formed into a single integrated electronics package. In various embodiments, the processor 308 may include processors from Intel® Corporation of Santa Clara, California, from Advanced Micro Devices, Inc. (AMD) of Sunnyvale, California, or from ARM Holdings, LTD., of Cambridge, England. Any number of other processors from other suppliers may also be used.

The processor 308 may communicate with other components of the controller 302 over a bus 310. The bus 310 may include any number of technologies, such as industry standard architecture (ISA), extended ISA (EISA), peripheral component interconnect (PCI), peripheral component interconnect extended (PCIx), PCI express (PCIe), or any number of other technologies. The bus 310 may be a proprietary bus, for example, used in an SoC based system. Other bus technologies may be used, in addition to, or instead of, the technologies above.

The bus 310 may couple the processor 308 to a memory 312. In some embodiments, such as in PLCs and other process control units, the memory 312 is integrated with a data store 314 used for long-term storage of programs and data. The data store 314 includes modules. As used herein, a module is a block of stored instructions in the data store that, when executed, directs the processor to implement a function of the system or of the automated solution preparation instrument. The memory 312 include any number of volatile and nonvolatile memory devices, such as volatile random-access memory (RAM), static random-access memory (SRAM), flash memory, and the like. In smaller devices, such as PLCs, the memory 312 may include registers associated with the processor itself. The data store 314 is used for the persistent storage of information, such as data, applications, operating systems, and so forth. The data store 314 may be a nonvolatile RAM, a solid-state disk drive, or a flash drive, among others. In some embodiments, the data store 314 will include a hard disk drive, such as a micro hard disk drive, a regular hard disk drive, or an array of hard disk drives, for example, associated with a DCS or a cloud server.

The bus 310 couples the processor 308 to a sensor interface 316. The sensor interface 316 connects the controller 302 to the sensors used to control components of the instrument. In some embodiments, the sensor interface 316 is a bank of analog-to-digital converters (ADCs), an I2C bus, a serial peripheral interface (SPI) bus, or a Fieldbus®, and the like. In some embodiments, the instrument includes storage sensors 318, vessel sensors 320, titration sensors 322, and optionally additional sensors 324. Additional sensors can include pH sensors, conductivity sensors, temperature sensors, level sensors, or any combination thereof. The storage sensors are located within storage tanks 116. The vessels sensors are disposed in the working solution vessel 124 and the standard solution vessel 144. In some implementations, the storage sensors are level sensors. The level sensors can detect the level of the solution in the tanks or containers, ensuring proper filling or preventing overflow. The titration sensors can be one or more sensors located in the titration reaction vessel 168. The storage sensors, vessel sensors, titration sensors may include temperature sensors, conductivity sensors, ion sensors, optical sensors, or float sensors, among others.

In some embodiments, the sensors include an ion sensor. In some embodiments, the ion sensor is a sodium ion sensor, a pH sensor, an oxidation-reduction potential (ORP) sensor, or a chloride ion sensor, among others. In some embodiments, the sensors include a pH sensor. The pH sensor can measure the acidity or alkalinity of a solution by detecting the concentration of hydrogen ions. In some embodiments, the sensors include a conductivity sensor. The conductivity sensor can determine the ability of a solution to conduct electricity, which can indicate the presence of dissolved ions or contaminants. In some implementations, the sensors can include a temperature sensor. The temperature sensor can monitor the temperature of a solution, ensuring it remains within the desired range for the preparation process. In some embodiments, combinations of different types of sensors may be used.

In some embodiments, to control the chemical solution preparation equipment, the sensors are connected to a control system or a programmable logic controller (PLC). The control system receives input from the sensors and processes the data to make decisions and adjustments. Based on the sensor readings, the control system can activate or adjust various components of the equipment, such as pumps, valves, heaters, or mixers, to maintain the desired conditions for solution preparation.

The control system can be programmed with setpoints and parameters that define the optimal conditions for the solution preparation process. If the sensor readings deviate from the setpoints or predefined ranges, the control system can trigger alarms, initiate corrective actions, or adjust the equipment settings to bring the solution back to the desired state.

The specific control mechanisms and algorithms may vary depending on requirements of the chemical solution preparation process. Industrial automation technologies, such as supervisory control and data acquisition (SCADA) systems or distributed control systems (DCS), can be used to provide advanced control and monitoring capabilities for the system. For example, the system can be used to monitor and prepare samples at a remote site with remote control.

The bus 310 couples the processor 308 to a control interface 326 is used to couple the controller 302 to controls used to operate the instrument. In some embodiments, the controller interface 326 is a bank of relays, a bank of MOSFET power controllers, a serial peripheral interface (SPI), or a Fieldbus, and the like. In some embodiments, the controls include valves 328. In some embodiments, the valves are solenoid control valves, for example, that open when energized and close when deenergized. In some embodiments, the controls include fluid or solid transfer devices 330.

The bus 310 couples the processor 308 to a human machine interface (HMI) 332. The HMI 332 couples the controller 302 to a control panel 106, as described with respect to FIG. 1A. As discussed herein, in some embodiments, the controller 302 may be co-located with the control panel 106 in a single enclosure.

The data store 314 includes modules which are blocks of stored instructions that, when executed, direct the processor 308 to implement the functions of the controller 302. As used herein, a module is a block of stored instructions in the data store that, when executed, direct the process to implement a function of the system or of the automated solution preparation instrument. The data store 314 includes a module 336 which is a block of instructions to direct the processor to open or close valves. For example, the instructions may instruct valves between the storage tanks and the working or standard solution vessels to open or close. In various embodiments, this is performed by activating relays to energize solenoid valves for opening and deactivating relays to deenergize solenoids allowing valves to close. The data store 314 includes a module 340 which is a block of instructions to direct the processor to monitor the levels in each of the storage tanks 116 using the storage sensors 318.

The data store 314 includes a module 342 which is a block of instructions to direct the processor to implement the program for the instrument 100. For example, the program can be a program to prepare a certain solution of a specific concentration. The data store 314 includes a module 344 which is a block of instructions to direct the processor to prepare a working solution, i.e., a working solution preparation module 344. The data store 314 includes a module 346 which is a block of instructions to direct the processor to prepare a standard solution, i.e., a standard solution preparation module 346. The data store 314 includes a module 348 which is a block of instructions to direct the processor to titrate the working solution with the standard solution, i.e., a titration module 348.

### Example 1: Preparation of a Dilute Solution

The instrument can prepare a dilute solution from a concentrated stock solution. The equation for preparing a dilute solution can be expressed as:

$${C}_{1} {V}_{1} = {C}_{2} {V}_{2} \qquad Eq . 1$$

where C₁ is the concentration of the concentrated stock solution, V₁ is the volume of the concentrated stock solution, C₂ is the desired concentration of the working solution, and V2 is the desired volume of the working solution.

To prepare 200 mL of a 2M hydrochloric acid (HCl) solution from a stock solution of 10M HCl, the equation is:

(10M)(V₁)=(2M)(200 mL)

In this example, V₁=40 mL and 40 mL of the stock solution should be diluted with 160 mL of solvent. Accordingly, given a known concentration of a stock solution, and a desired concentration and volume of a working solution, the instrument 100 can prepare the working solution by adding the correct volume of the stock solution and diluting with the correct amount of solvent, for example deionized water.

### Example 2: Preparation of a Working Solution from a Stock of Solid Chemical

To prepare a solution from a solid amount of a compound, the equation is:

$${V}_{1} ( {C}_{1} ) ( molar mass compound ) = g compound \qquad Eq . 2$$

where V₁ is the desired volume of solution in liters, C₁ is the desired concentration of a solution in Molarity (moles/liter), and the molar mass of the compound is given in grams/mole.

To prepare 500 mL (0.5 L) of a 0.1 M (0.1 mol/L) sodium hydroxide (NaOH) solution from a mass of solid NaOH, the equation is:

$$( 0.5 L ) ( 0.1 \frac{mol}{L} ) ( 40 \frac{g}{mol} ) = 2 g NaOH$$

Accordingly, to prepare 500 mL of a 0.1 M NaOH solution, the instrument will mix 500 mL of solvent, for example, deionized water, with 2 g of NaOH.

### Example 3: Preparation of a Buffer Solution

A buffer solution is a solution that maintains a stable pH, even with the addition of an acid or base. The equation for preparing a buffer solution can be written as:

$$pH = {pK}_{a} + log ( \frac{[ base ]}{[ acid ]} ) \qquad Eq . 3$$

wherein pH is the desired pH of the buffer solution, pKa is the pKa of a weak acid, [base] is the concentration of the conjugate base of the weak acid, and [acid] is the concentration of the weak acid.

To prepare a buffer solution with a pH of 5.0 using acetic acid, where the pKa of acetic acid is 4.75, the equation is:

$$5. = 4.75 + log ( \frac{[ base ]}{[ acid ]} )$$

Accordingly, the ratio of acetate (the conjugate base of acetic acid) to the concentration of the acid must be 1.78. For a buffer solution with a pH of 5.0 and assuming a stock solution with a 0.10 M concentration of acetic acid, the amount of conjugate base (acetate ion) to be added to the stock solution can be calculated with:

$$1.78 = \frac{[ acetate ]}{[ 0.1 M ]}$$

Accordingly, the concentration of acetate ion should be 0.178 M. To prepare 500 mL of this solution, the amount of sodium acetate to add to 500 mL of 0.1 M acetic acid can be calculated as:

$$( 0.5 L ) ( 0.178 \frac{mol}{L} sodium acetate ) ( 82 \frac{g}{mol} ) = 7.3 g sodium acetate$$

Accordingly, the instrument can add 7.3 g of sodium acetate to 500 mL of a 0.1 M acetic acid stock solution to prepare a buffer solution with a pH of 5.0.

The term “about” as used in this disclosure can allow for a degree of variability in a value or range, for example, within 10%, within 5%, or within 1% of a stated value or of a stated limit of a range.

The term “substantially” as used in this disclosure refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “solvent” as used in this disclosure refers to a liquid that can dissolve a solid, another liquid, or a gas to form a solution. Non-limiting examples of solvents are silicones, organic compounds, water, alcohols, ionic liquids, and supercritical fluids.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

A number of implementations of the disclosure have been described. Nevertheless, it will be understood that various modifications may be made without departing from the spirit and scope of the disclosure.

### EMBODIMENTS

In some implementations, a system for preparing and quantifying a chemical solution includes a control panel configured to control a process for preparing and quantifying a solution, a plurality of storage tanks configured to store solvents, solutions, and/or solutes, a working solution section, a standard solution section, a titration section and a controller including a processor and a data store. The data store includes a working solution module, wherein the working solution module includes instructions to direct the processor to prepare a working solution from solvents, solutions and/or solutes stored in the storage tanks, wherein the working solution is prepared in the working solution section. The data store includes a standard solution module, wherein the standard solution module includes instructions to direct the processor to prepare a standard solution from solvents, solutions and/or solutes, wherein the standard solution is prepared in the standard solution section. The data store includes a titration module, wherein the titration module includes instructions to direct the processor to titrate a portion of the working solution using a portion of the standard solution.

In an example implementation combinable with any other example implementation, the system includes a scale, wherein the data store includes instructions to direct the processor to weigh a portion of solute from the storage tanks using the scale and transfer the weighed solute to the working solution section or the standard solution section.

In an example implementation combinable with any other example implementation, the working solution section includes a first docking region, a working solution vessel placed on the first docking region, and a working chemical and solvent dispenser, wherein the working chemical and solvent dispenser is in fluid communication with the storage tanks and the scale, and wherein the working and chemical solvent dispenser is disposed over the first docking region and configured to dispense chemicals and solvent into the working solution vessel.

In an example implementation combinable with any other example implementation, the first docking region includes at least one of a heating element, a cooling element, or any combination thereof.

In an example implementation combinable with any other example implementation, the standard solution section includes a second docking region, a standard solution vessel placed on the second docking region, and a standard chemical and solvent dispenser, wherein the standard chemical and solvent dispenser is in fluid communication with the storage tanks and the scale, and wherein the standard chemical and solvent dispenser is disposed over the second docking region and configured to dispense chemicals and solvent into the standard solution vessel.

In an example implementation combinable with any other example implementation, the second docking region includes at least one of a heating element, a cooling element, or any combination thereof.

In an example implementation combinable with any other example implementation, the titration section includes a titration reaction vessel in fluid communication with the working solution section and the standard solution section, and a reaction probe.

In an example implementation combinable with any other example implementation, the control panel includes an interface wherein a user can program or select a chemical solution preparation and quantification program.

In an example implementation combinable with any other example implementation, the system includes an inert gas inlet in fluid communication with the working solution section and the standard solution section, wherein the inert gas inlet is configured to direct an inert gas through a solution in the working solution section, a solution in the standard solution section, or both.

In an example implementation combinable with any other example implementation, the system includes an inert gas source in fluid communication with the inert gas inlet.

In some implementations, a method for preparing and quantifying a chemical solution using an automated solution preparation instrument includes accepting target values for a working solution, and in response to the target values, weighing an amount of solid chemical or partitioning an amount of liquid, dispensing the amount of solid chemical or the amount of liquid into a working solution vessel, dispensing an amount of solvent into the working solution vessel to yield a working solution, dispensing an amount of standard solution to a standard solution vessel, transferring a portion of the working solution to a titration section, and titrating the portion of the working solution using a portion of the standard solution.

In an example implementation combinable with any other example implementation, the method includes stirring the working solution.

In an example implementation combinable with any other example implementation, the method includes heating the working solution.

In an example implementation combinable with any other example implementation, the method includes cooling the working solution.

In an example implementation combinable with any other example implementation, the method includes purging the working solution with an inert gas.

In an example implementation combinable with any other example implementation, the method includes, in response to the titration, the instrument altering the working solution in the working solution vessel.

In an example implementation combinable with any other example implementation, altering the working solution includes diluting the working solution in the working solution vessel.

In an example implementation combinable with any other example implementation, altering the working solution includes adding solute to the working solution in the working solution vessel.

In an example implementation combinable with any other example implementation, altering the working solution includes adding acid to the working solution in the working solution vessel.

In an example implementation combinable with any other example implementation, altering the working solution includes adding base to the working solution in the working solution vessel.

What is claimed is:

1. A system for preparing and quantifying a chemical solution, the system comprising:
a control panel configured to control a process for preparing and quantifying a solution;
a plurality of storage tanks configured to store solvents, solutions, and/or solutes;
a working solution section;
a standard solution section;
a titration section; and
a controller comprising a processor and a data store, wherein the data store comprises:
a working solution module, wherein the working solution module comprises instructions to direct the processor to prepare a working solution from solvents, solutions and/or solutes stored in the storage tanks, wherein the working solution is prepared in the working solution section;
a standard solution module, wherein the standard solution module comprises instructions to direct the processor to prepare a standard solution from solvents, solutions and/or solutes, wherein the standard solution is prepared in the standard solution section; and
a titration module, wherein the titration module comprises instructions to direct the processor to titrate a portion of the working solution using a portion of the standard solution.

2. The system of claim 1, further comprising a scale, wherein the data store comprises instructions to direct the processor to weigh a portion of solute from the storage tanks using the scale and transfer the weighed solute to the working solution section or the standard solution section.

3. The system of claim 2, wherein the working solution section comprises:
a first docking region;
a working solution vessel placed on the first docking region; and
a working chemical and solvent dispenser, wherein the working chemical and solvent dispenser is in fluid communication with the storage tanks and the scale, and wherein the working and chemical solvent dispenser is disposed over the first docking region and configured to dispense chemicals and solvent into the working solution vessel.

4. The system of claim 3 wherein the first docking region comprises at least one of a heating element, a cooling element, or any combination thereof.

5. The system of claim 2, wherein the standard solution section comprises:
a second docking region;
a standard solution vessel placed on the second docking region; and
a standard chemical and solvent dispenser, wherein the standard chemical and solvent dispenser is in fluid communication with the storage tanks and the scale, and wherein the standard chemical and solvent dispenser is disposed over the second docking region and configured to dispense chemicals and solvent into the standard solution vessel.

6. The system of claim 5, wherein the second docking region comprises at least one of a heating element, a cooling element, or any combination thereof.

7. The system of claim 2, wherein the titration section comprises:
a titration reaction vessel in fluid communication with the working solution section and the standard solution section; and
a reaction probe.

8. The system of claim 1, wherein the control panel comprises an interface wherein a user can program or select a chemical solution preparation and quantification program.

9. The system of claim 1, further comprising an inert gas inlet in fluid communication with the working solution section and the standard solution section, wherein the inert gas inlet is configured to direct an inert gas through a solution in the working solution section, a solution in the standard solution section, or both.

10. The system of claim 9, further comprising an inert gas source in fluid communication with the inert gas inlet.

11. A method for preparing and quantifying a chemical solution using an automated solution preparation instrument, the method comprising:
accepting target values for a working solution, and in response to the target values,
weighing an amount of solid chemical or partitioning an amount of liquid,
dispensing the amount of solid chemical or the amount of liquid into a working solution vessel,
dispensing an amount of solvent into the working solution vessel to yield a working solution,
dispensing an amount of standard solution to a standard solution vessel,
transferring a portion of the working solution to a titration section, and
titrating the portion of the working solution using a portion of the standard solution.

12. The method of claim 11, wherein the method further comprises stirring the working solution.

13. The method of claim 11, wherein the method further comprises heating the working solution.

14. The method of claim 11, wherein the method further comprises cooling the working solution.

15. The method of claim 11, wherein the method further comprises purging the working solution with an inert gas.

16. The method of claim 11, wherein, in response to the titration, the instrument alters the working solution in the working solution vessel.

17. The method of claim 16, wherein altering the working solution comprises diluting the working solution in the working solution vessel.

18. The method of claim 16, wherein altering the working solution comprises adding solute to the working solution in the working solution vessel.

19. The method of claim 16, wherein altering the working solution comprises adding acid to the working solution in the working solution vessel.

20. The method of claim 16, wherein altering the working solution comprises adding base to the working solution in the working solution vessel.
